(19) United States
(12) Patent Application Publication
(10) Pub. No.: US 2003/0125035 A1
(43) Pub. Date: Jul. 3, 2003

(54) Burst scheduling in a wireless communication system

(76) Inventors: Farid T. Khafizov, Plano, TX (US); Mehmet Yavuz, Plano, TX (US)

Correspondence Address: Bruce E. Garlick, P.O. Box 160727, Austin, TX, 78716-0727, US

(21) Appl. No.: 10/256,945

(22) Filed: Sep. 27, 2002

Related U.S. Application Data
(60) Provisional application No. 60/342,056, filed on Dec. 19, 2001.

(51) Int. Cl. H04Q 7/20

(52) U.S. Cl. 455/450; 455/451; 455/462

(57) ABSTRACT

A method for servicing data communications in a cellular wireless communication system supports data communications on fundamental channels (FCHs) and supplemental channels (SCHs). The method includes first determining an operational relationship between a burst duration and a burst delay of the SCHs and Transmission Control Protocol (TCP) layer throughput provided by the cellular wireless communication system. The operational relationship relates TCP layer throughput as a function of the burst duration and burst delay of the SCHs. Then, the method includes servicing, by a base station of the cellular wireless communication system, data communications for a plurality of wireless terminals using a plurality of FCHs and at least one SCH. In servicing the data communications, the burst duration and the burst delay of the at least one SCH are managed in an attempt to provide a minimal TCP layer throughput degradation for at least some of the plurality of wireless terminals.

### CROSS REFERENCE TO RELATED APPLICATION

This application claims priority to U.S. Provisional Application Serial No 60/342,056, filed Dec. 19, 2001, the disclosure of which is incorporated herein by reference in its entirety.

### BACKGROUND

1. Technical Field

The present invention relates generally to cellular wireless communication systems; and more particularly to the transmission of data communications in cellular wireless communication systems.

2. Related Art

Cellular wireless communication systems support wireless communication services in many populated areas of the world. While cellular wireless communication systems were initially constructed to service voice communications, they are now called upon to support data communications as well. The demand for data communication services has exploded with the acceptance and widespread use of the Internet. While data communications have historically been serviced via wired connections, cellular wireless users now demand that their wireless units also support data communications. Many wireless subscribers now expect to be able to “surf” the Internet, access their email, and perform other data communication activities using their cellular phones, wireless personal data assistants, wirelessly linked notebook computers, and/or other wireless devices. The demand for wireless communication system data communications will only increase with time. Thus, cellular wireless communication systems are currently being created/modified to service these burgeoning data communication demands.

Significant performance issues exist when using a cellular wireless communication system to service data communications. Cellular wireless communication systems were initially designed to service the well-defined requirements of voice communications. Generally speaking, voice communications require a sustained bandwidth with minimum signal-to-noise ratio (SNR) to satisfy Quality of Service (QoS) and continuity requirements. Data communications, on the other hand, have very different performance requirements. Data communications are typically bursty, discontinuous, and may require a relatively high bandwidth during their active portions.

To understand the difficulties in servicing data communications within a cellular wireless communication system, it is best to first consider the structure and operation of a cellular wireless communication system. Cellular wireless communication systems include a “network infrastructure” that wirelessly communicates with wireless terminals within a respective service coverage area. The network infrastructure typically includes a plurality of base stations dispersed throughout the service coverage area, each of which supports wireless communications within a respective cell (or set of sectors). The base stations couple to base station controllers (BSCs), with each BSC serving a plurality of base stations. Each BSC couples to a mobile switching center (MSC). Each BSC also typically directly or indirectly couples to the Internet.

In operation, a wireless subscriber unit communicates with one (or more) of the base stations. Transmissions from a base station to a wireless subscriber unit are referred to as “forward link” transmissions and transmissions from a wireless subscriber unit to its servicing base station are referred to as “reverse link” transmissions. A BSC coupled to the serving base station routes voice communications between the MSC and the serving base station. The MSC routes the voice communication to another MSC or to the public switched telephone network (PSTN). BSCs route data communications between a servicing base station and a packet data network that couples to the Internet and other networks. The wireless link between the base station and the wireless subscriber unit is defined by one of a plurality of operating standards, e.g., AMPS, TDMA, CDMA, GSM, etc. These operating standards, as well as new 3G and 4G operating standards, define the manner in which the wireless link may be allocated, setup, serviced and torn down. Generally, a wireless link between a base station and a serviced wireless subscriber unit is serviced by a respective wireless channel that is time varying. Data that is transmitted between the base station and the serviced wireless subscriber unit is arranged in physical layer frames that typically carry a preamble, a header, data, and a trailer.

Each base station supports a number of wireless terminals but is limited in its total transmit power. This total transmit power must be allocated among the number of serviced users. Because of limitations on allocated transmit power and because of the time varying nature of respective wireless channels corresponding to the number of serviced users, the data carried by any particular physical layer frame may be received erroneously. Such an event is referred to as a “frame error”. The rate at which frame errors occur is known as the Frame Error Rate (FER). While some wireless cellular systems include mechanisms at the physical layer to detect frame errors, other wireless cellular systems do not include error detection at the physical layer and rely upon higher protocol layer operations to detect such errors. As is known, as allocated transmit power is increased, FER decreases, and vice versa. However, an increase in the transmit power for any given link increases interference and typically reduces the transmit power that may be allocated to other links.

Operation of many higher protocol layers requires error free delivery of data. In an attempt to provide error free delivery of data, higher layer protocols such as the Radio Link Protocol (RLP) layer and the Transmission Control Protocol (TCP) layer include Automatic Repeat reQuest (ARQ) operations. With negative ARQ operations, a Negative AcKnowledgement (NAK) is sent from a receiving device to a transmitting device when the receiving device erroneously receives a data segment or when the receiving device determines that a transmitted data segment has been lost, e.g., when data segments surrounding a lost data segment have been received. The NAK identifies the data segment and, upon receipt of the NAK, the transmitting device retransmits the data segment.

With positive ARQ operations, an ACKnowledgement (ACK) is sent from a receiving device to a transmitting device when the receiving device correctly receives data. The transmitting device determines that retransmission is required when an ACK is not received for a respective data segment within a particular period of time, i.e., before a Retransmission Time Out (RTO) period expires. The transmitting device sets a RTO timer for each data segment upon its transmission. If the RTO timer for the data segment expires prior to receipt of a corresponding ACK, the transmitting device automatically retransmits the data segment.

Many Internet applications such as http, ftp, and email run on TCP. TCP uses positive ARQ operation and RTO detection. Fundamental to TCP timeout and retransmission is the measurement of the round-trip time (RTT) experienced during a data call. RTT changes over time and a servicing TCP layer tracks these changes and keeps updating the RTO value. When RTO expires, the TCP layer treats unacknowledged data segments as lost and retransmits the “lost” data segments. Sometimes, however, RTO may expire prematurely. In such case, unnecessary retransmissions of data will result.

In a cellular wireless communication systems, the RTT value, its mean deviation, and packet loss are all often high. Therefore, existing RTO calculation algorithms are generally inadequate for TCP layers serviced by cellular wireless communication systems, especially in the case of “finite burst” data communications. With “finite burst” data communications, Supplemental Channels (SCHs) are constantly allocated and released. For example, in one mode of 1xRTT operations (finite burst) in which one or more SCH(s) is shared among a plurality of users, each SCH is allocated to one of the users, released from the user after 5.12 seconds, and then reallocated to the user (or another user) after a delay period, e.g., 1 second. This pattern of allocation, release, and reallocation continues until the completion of the data communication. These operations result in fluctuating bandwidth, from the perspective of the TCP layer, where bandwidth oscillates as the SCH is allocated and released during the data communication. In many operations, the fluctuating bandwidth provided by the wireless link destructively interacts with the TCP layer ARQ operations resulting in significant unnecessary retransmissions of data segments, significantly reducing the quality of data communication service provided.

Thus, there exists a need in the art for improved operations that may be used within cellular wireless communication systems that support fluctuating bandwidth operations.

### SUMMARY OF THE INVENTION

In order to overcome the shortcomings of the prior operations, among other shortcomings, a method for servicing data communications in a cellular wireless communication system includes supporting data communications on fundamental channels (FCHs) and supplemental channels (SCHs). The method includes first determining an operational relationship between a burst duration and a burst delay of the SCHs and Transmission Control Protocol (TCP) layer throughput provided by the cellular wireless communication system. The operational relationship relates TCP layer throughput as a function of the burst duration and burst delay of the SCHs. Then, the method includes servicing, by a base station of the cellular wireless communication system, data communications for a plurality of wireless terminals using a plurality of FCHs and at least one SCH. In servicing the data communications, the burst duration and the burst delay of the at least one SCH are managed in an attempt to provide a minimal TCP layer throughput degradation for at least some of the plurality of wireless terminals.

The method of the present invention may be implemented by various cellular wireless communication system components and other components. The operational relationship may be determined off-line using a computer simulation tool such as Network Simulator, which is a discrete event simulator targeted at networking research, or one of the OPNET simulation tools, for example. Once determined, the operational relationship is then downloaded to a wireless communication system component(s) that will perform the management of the burst duration and the burst delay. In one embodiment of the present invention, a Radio Resource Manager (RRM) operating on a respective base station will perform these management operations. In other embodiments, a Base Station Controller (BSC) or other network component performs these management operations. The particular manner in which the present invention accomplishes these operations, of course, could be performed in other ways as well.

The operational relationship may also be a function of bandwidth ratio of the SCHs and FCHs. In such case, the base station (or other system component) also manages the bandwidth ratio of the at least one SCH and the plurality of FCHs in an attempt to provide a minimal TCP layer throughput degradation for at least some of the plurality of wireless terminals. In these operations, the bandwidth ratio may be equal to the sum of a SCH bandwidth and a FCH bandwidth divided by the FCH bandwidth.

According to other aspects of the present invention, (1) operation of the present invention may also include managing the allocation of the at least one SCH in an attempt to provide a minimal TCP layer throughput degradation for at least some of the plurality of wireless terminals; (2) TCP layer throughput degradation may be characterized as a percentage of maximum allowable TCP throughput; (3) managing the burst duration and the burst delay of the at least one SCH may be performed so that at least some of the plurality of wireless terminals receives at least a minimum percentage of maximum allowable TCP throughput; (4) managing the burst duration and the burst delay of the at least one SCH may be performed so that each of the plurality of wireless terminals receives at least a minimum percentage of maximum allowable TCP throughput; and (5) managing the burst duration and burst delay of the at least one SCH may be performed in an attempt to provide a minimal TCP layer throughput degradation for at least some of the plurality of wireless terminals is performed by a Radio Resource Manager operating at the base station. In any of the above-described operations, at least one SCH may be shared by the plurality of wireless terminals and/or the at least one SCH may include a plurality of SCHs.

Other features and advantages of the present invention will become apparent from the following detailed description of the invention made with reference to the accompanying drawings.

### BRIEF DESCRIPTION OF THE DRAWINGS

A better understanding of the present invention can be obtained when the following detailed description of the preferred embodiment is considered in conjunction with the following drawings, in which:

FIG. 1 is a system diagram illustrating a portion of a cellular wireless communication system constructed according to the present invention;

FIG. 2 is a graph illustrating fluctuating bandwidth that is provided during a data communication serviced by the cellular wireless communication system of FIG. 1;

FIG. 3A is a logic diagram illustrating operation according to the present invention in servicing a data communication;

FIG. 3B is a logic diagram illustrating in more detail the operation of FIG. 3A in managing burst duration and burst delay;

FIG. 4 is a block diagram illustrating a plurality of protocol layers that are supported according to the present invention;

FIG. 5 is a block diagram illustrating the structure of a base station that operates according to the present invention;

FIG. 6 is a block diagram illustrating the structure of a wireless subscriber unit that operates according to the present invention; and

FIG. 7 is a block diagram illustrating the structure of a Base Station Controller (BSC) that operates according to the present invention.

### DETAILED DESCRIPTION OF THE DRAWINGS

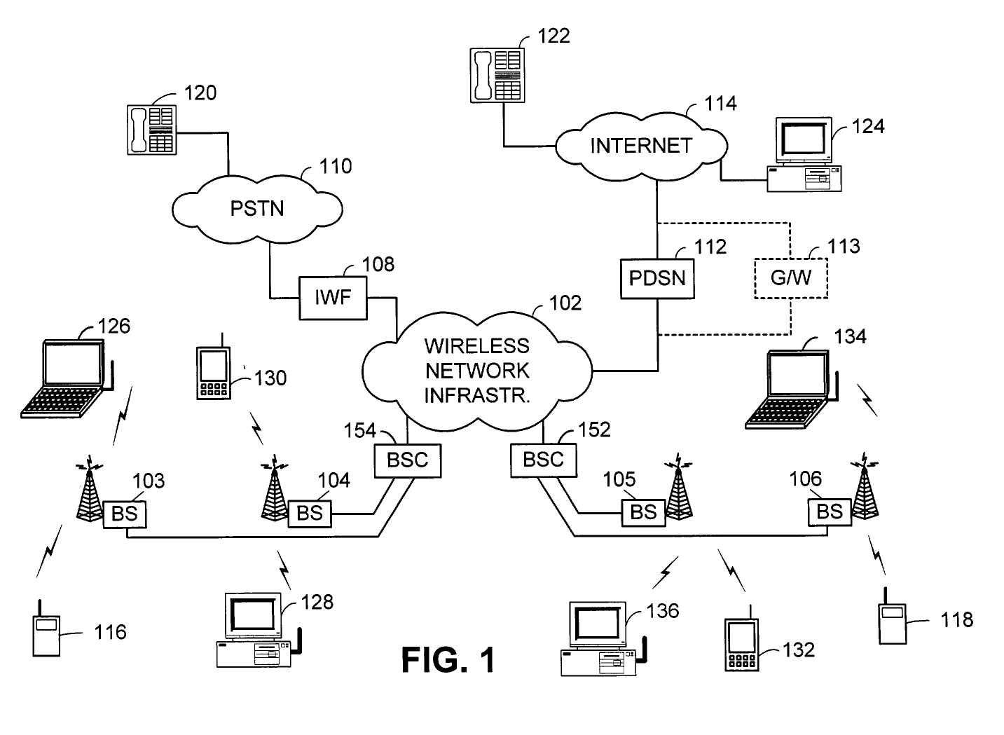

FIG. 1 is a system diagram illustrating a portion of a cellular wireless communication system constructed according to the present invention. The cellular wireless communication system includes a wireless network infrastructure 102, base station controllers (BSCs) 152 and 154, and base stations 103, 104, 105, and 106. The wireless network infrastructure 102 couples to the Internet 114. The wireless network infrastructure 102 also couples to the Public Switched Telephone Network (PSTN) 110. In one embodiment of the present invention, the wireless network infrastructure 102 is circuit switched, couples directly to the PSTN 110, and couples to the Internet 114 via a gateway (G/W) 113. In another embodiment of the present invention, the wireless network infrastructure 102 is packet switched, couples to the Internet 114 via a Packet Data Serving Node (PDSN) 112, and couples to the PSTN 110 via an interworking function (IWF) 108.

A conventional voice terminal 120 couples to the PSTN 110. A Voice over Internet Protocol (VoIP) terminal 122 and a personal computer 124 couple to the Internet 114. Wireless terminals 116, 118, 126, 128, 130, 132, 134, and 136 couple to the cellular wireless communication system via wireless links with the base stations 103-106. As illustrated, wireless terminals may include cellular telephones 116 and 118, laptop computers 126 and 134, desktop computers 128 and 136, and data terminals 130 and 132. However, the wireless system supports communications with other types of wireless terminals as well.

Each of the base stations 103-106 services a cell/set of sectors within which it supports wireless communications. Wireless links that include both forward link components and reverse link components support wireless communications between the base stations and their serviced wireless terminals. These wireless links support data communications, VoIP and other multimedia communications. The teachings of the present invention may be applied equally to any type of communication application that utilizes TCP.

The cellular wireless communication system operates according to a wireless standard that has been modified according to the present invention. Examples of such wireless standards include CDMA standards such a 1xRTT, 1xEV-DO, 1xEV-DV, UMTS, etc. However, the present invention is also applicable to other standards as well, e.g., TDMA standards, GSM standards, etc. The cellular wireless communication system supports both voice and data traffic. However, operations according to the present invention relate to the service of high-rate data communications. As is generally known, devices such as laptop computers 126 and 134, desktop computers 128 and 136, data terminals 130 and 132, and cellular telephones 116 and 118, are enabled to “surf” the Internet 114, transmit and receive data communications such as email, transmit and receive files, and to perform other data operations. Many of these data operations have significant download data-rate requirements while the upload data-rate requirements are not as severe.

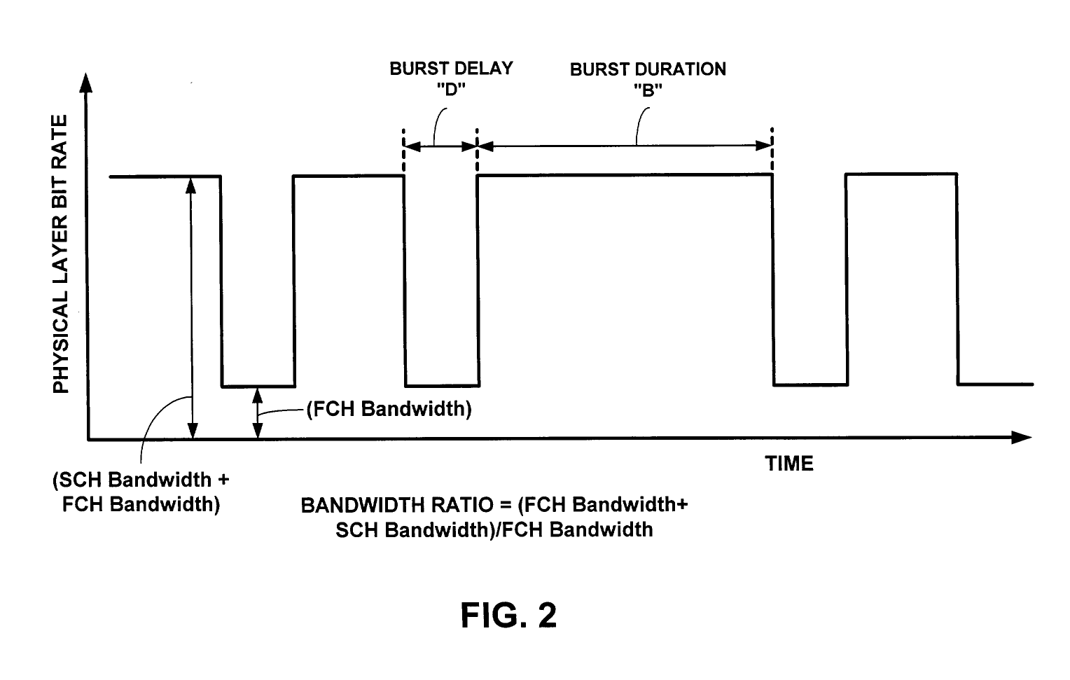

FIG. 2 is a graph illustrating fluctuating bandwidth that is provided during a data communication to a wireless terminal that is serviced by the cellular wireless communication system of FIG. 1. The graph of FIG. 2 represents a wireless forward link that services the data communication between wireless subscriber unit 134 and web server 124, for example. This wireless forward link is provided by base station 106 with the wireless terminal 134 in its current location. Such cellular wireless service may be provided according to the 1xRTT standard, for example. With the system of FIG. 1 operating according to the 1xRTT standard, a servicing base station 106 transmits forward link data over two types of traffic channels, the Fundamental Channel (FCH) and the Supplemental Channel (SCH). A single reverse link channel typically services the reverse link.

The fundamental channel has a fixed low bandwidth (e.g., 9.6 or 14.4 kbps). The SCH Bandwidth is typically a multiple of the bandwidth that is provided by the FCH, e.g., as high as 32 times (32×) the FCH Bandwidth in some systems, 16× in the example of FIG. 2. The bandwidth ratio of the SCH to the FCH is denoted as “O” and is determined in one embodiment as O=((SCH Bandwidth+FCH Bandwidth)/FCH Bandwidth). While allocated, the total bandwidth of the wireless link that is serviced by the FCH (1×) and the SCH (16×) and the wireless link provides a total bandwidth of (FCH Bandwidth+SCH Bandwidth=16×+1×), as indicated as a bit rate.

As is illustrated in FIG. 2, during all times while the data communication is active a minimum bandwidth (represented by 1×) is provided by the FCH. Also during the data communication, the SCH is allocated and released on a regular basis. When the SCH is allocated to a wireless terminal, the communication is said to be in “burst.” There are two types of SCH assignments: finite and infinite, which will be referred to as finite burst and infinite burst, respectively. Infinite burst means that SCH can be used for transmitting data until a release command is issued. Finite burst mode of operation limits the SCH usage to one of fourteen finite time intervals before it must be released. After the SCH is released, it can be acquired again after a burst delay.

Associated with the SCH are burst duration “B” and burst delay “D”. The burst duration B is the duration of the period during which the SCH is active. The burst delay D is the duration of the period between a release of the SCH and a subsequent allocation of the SCH. The burst duration B, the burst delay D, and the bandwidth ratio O are controllable by a Radio Resource Manager (RRM) operating within the cellular wireless communication system, typically within the servicing base station 106. Of course, in other embodiments, B, D, and O are controlled by another component of the cellular wireless communication system.

The RTO computation algorithm of the TCP layer was designed to follow closely round trip time (RTT), but is known to work poorly when RTT delay variance is high. During a high bandwidth burst (FCH+SCH), RTT is low and, if B is relatively long (e.g., 5.12 seconds), RTO converges to RTT. When the SCH is released, the RTT suddenly increases (proportionally to O) and the RTO expires thereby forcing TCP into data recovery operations, even though none of the corresponding TCP data segments were lost.

When TCP parameters are fixed for a TCP layer serviced by a wireless link, the level of throughput degradation (and achievable throughput) is a function of <O, B, D>. For some combinations of <O, B, D>degradation of throughput may reach 55%. When B and/or D are low, the throughput degradation is less severe. However, deploying 1xRTT systems with low B and/or D values is generally impractical because of the significant overhead resources consumed that could otherwise be used to transmit data. Higher throughput is achieved when B is high, while signaling delays impose limits on reducing D. Avoiding the finite burst mode of operation is also not a practical manner of operation because limited RF resources require time-sharing of SCH resources (e.g., scheduling users). Thus, operation according to the present invention includes managing B, D, and O at the physical and/or MAC layer of a servicing base station 106 to ensure that destructive interaction between the physical layer and/or MAC layer and serviced TCP layers does not occur.

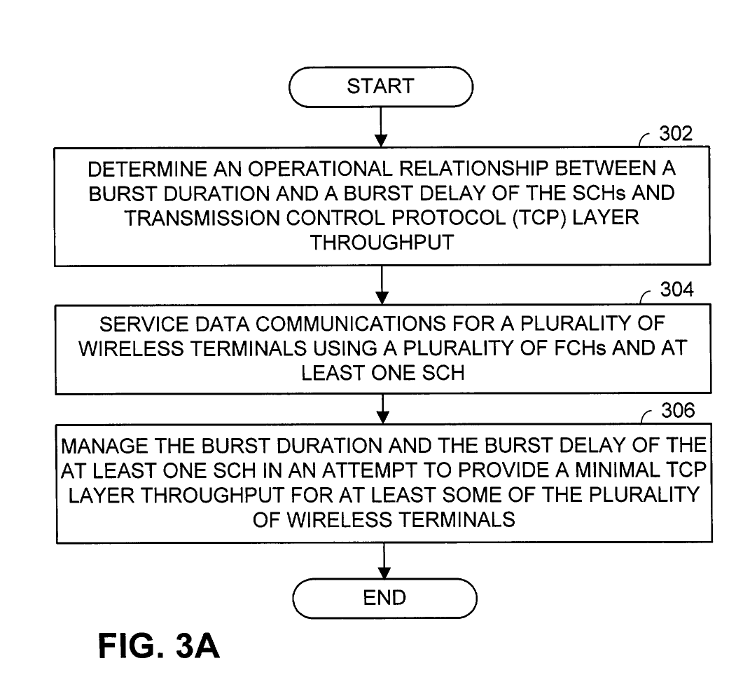

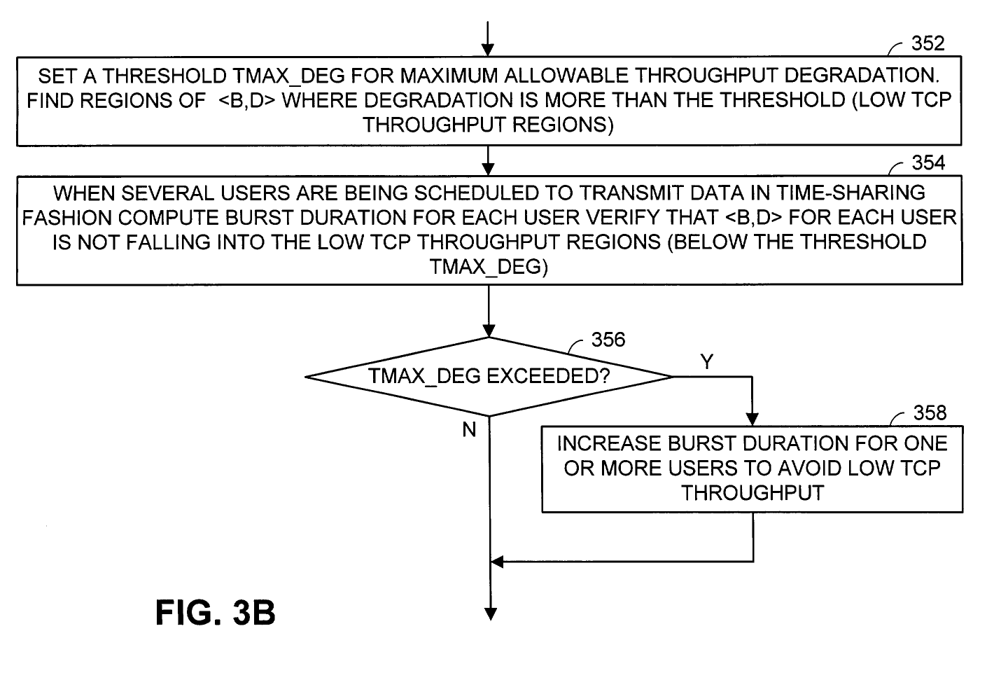

FIG. 3A is a logic diagram illustrating operation according to the present invention in servicing a data communication with which data communications are serviced on fundamental channels (FCHs) and supplemental channels (SCHs). The method includes first determining an operational relationship between a burst duration and a burst delay of the SCHs and Transmission Control Protocol (TCP) layer throughput provided by the cellular wireless communication system (step 302). The operational relationship relates TCP layer throughput as a function of the burst duration and burst delay of the SCHs. Then, the method includes servicing, by a base station of the cellular wireless communication system, data communications for a plurality of wireless terminals using a plurality of FCHs and at least one SCH (step 304). In servicing the data communications, the burst duration and the burst delay of the at least one SCH are managed in an attempt to provide a minimal TCP layer throughput degradation for at least some of the plurality of wireless terminals (step 306).

The method of the present invention may be implemented by various cellular wireless communication system components and other components. For example, the operational relationship may be determined off-line using computer simulation tools such as Network Simulator, which is a discrete event simulator targeted at networking research, or one of the OPNET simulation tools, for example. Table 1 provides one example of the parameters that are employed in the simulation operation.

| Parameter | Value |
|---|---|
| Fwd. Link SCH Rate-High | 16x |
| Burst duration | 0 sec.-20 sec. |
| Fwd. Link SCH Rate-Low | 1x |
| Delay duration | 0 sec.-20 sec. |
| Rev. Link SCH Rate | 1x |
| TCP version | Reno (based on BSD 4.3) |
| Rtx_init | 3.0 sec. |
| Segs_per_ack | 2 |
| Delayed_ack | Enabled |
| RTO_min | 0.4 sec. |
| Window_size | 8 kB |

Table 1: Simulation Parameters for Bandwidth Oscillation Analysis

Once determined, the operational relationship is then downloaded to a wireless communication system component(s) that will perform the management of the burst duration and the burst delay. In one embodiment of the present invention, a Radio Resource Manager (RRM) operating on a respective base station will perform these management operations. In other embodiments, a Base Station Controller (BSC) or other network component performs these management operations. The particular manner in which the present invention accomplishes these operations, of course, could be performed in other ways as well.

The operational relationship may also be a function of bandwidth ratio of the SCHs and FCHs. In such case, the base station (or other system component) also manages the bandwidth ratio of the at least one SCH and the plurality of FCHs in an attempt to provide a minimal TCP layer throughput degradation for at least some of the plurality of wireless terminals. In these operations, the bandwidth ratio may be equal to the sum of a SCH bandwidth and a FCH bandwidth divided by the FCH bandwidth.

According to other aspects of the present invention, (1) operation of the present invention may also include managing the allocation of the at least one SCH in an attempt to provide a minimal TCP layer throughput degradation for at least some of the plurality of wireless terminals; (2) TCP layer throughput degradation may be characterized as a percentage of maximum allowable TCP throughput; (3) managing the burst duration and the burst delay of the at least one SCH may be performed so that at least some of the plurality of wireless terminals receives at least a minimum percentage of maximum allowable TCP throughput; (4) managing the burst duration and the burst delay of the at least one SCH may be performed so that each of the plurality of wireless terminals receives at least a minimum percentage of maximum allowable TCP throughput; and (5) managing the burst duration and burst delay of the at least one SCH may be performed in an attempt to provide a minimal TCP layer throughput degradation for at least some of the plurality of wireless terminals is performed by a Radio Resource Manager operating at the base station. In any of the above-described operations, at least one SCH may be shared by the plurality of wireless terminals and/or the at least one SCH may include a plurality of SCHs.

Table 2 illustrates the relative throughput of TCP compared to maximum allowable TCP throughput for various burst durations B and delay durations D. As Table 2 illustrates, with some combinations of B and D, TCP throughput decreases by as much as 40% of a maximum achievable throughput when unnecessary retransmissions are required.

TABLE 2
Relative TCP Throughput compared to Theoretical Maximum for Different
Values of Burst and Delay (<B,D>) for TCP_wnd = 8 kBytes.

| | | Burst Duration - B [sec] | | | | | | | | | | |
|---|---|---|---|---|---|---|---|---|---|---|---|---|
| | | 0.02 | 1 | 2 | 3 | 4 | 5 | 6 | 7 | 8 | 9 | 10 |
| Delay | 0.02 | 99% | 99% | 99% | 99% | 99% | 99% | 99% | 99% | 99% | 99% | 99% |
| Duration - D [sec] | 1 | 95% | 98% | 44% | 61% | 66% | 71% | 76% | 79% | 82% | 84% | 86% |
| | 2 | 95% | 97% | 47% | 59% | 66% | 74% | 77% | 81% | 83% | 85% | 86% |
| | 3 | 95% | 96% | 53% | 58% | 68% | 71% | 77% | 80% | 83% | 83% | 85% |
| | 4 | 94% | 96% | 53% | 64% | 66% | 74% | 78% | 82% | 82% | 85% | 87% |
| | 5 | 94% | 96% | 55% | 62% | 68% | 73% | 77% | 79% | 82% | 85% | 85% |
| | 6 | 94% | 95% | 51% | 61% | 67% | 73% | 76% | 80% | 83% | 84% | 84% |
| | 7 | 94% | 95% | 48% | 63% | 68% | 69% | 75% | 79% | 81% | 82% | 86% |
| | 8 | 94% | 94% | 46% | 59% | 68% | 74% | 78% | 81% | 82% | 85% | 85% |
| | 9 | 94% | 94% | 45% | 48% | 64% | 71% | 76% | 77% | 82% | 83% | 83% |
| | 10 | 94% | 94% | 47% | 57% | 61% | 67% | 70% | 76% | 81% | 79% | 84% |

For the simulated system, TCP throughput can be significantly improved by avoiding the low throughput regions of Table 2. For example Table 2 shows that a 2 second burst duration and 1 second delay duration selection will result in only 44% of maximum achievable throughput, and therefore should be avoided during system operation.

FIG. 3B is a logic diagram illustrating in more detail the operation of FIG. 3A in managing burst duration and burst delay. According to the operation of FIG. 3B, a given system configuration determines throughput degradation as a function of burst and delay duration (<B,D>) and downloads the information to a managing device, e.g., base station 106. In the base station 106 (or other device), a threshold T_{Max}^{_{—}}_{deg} is set for maximum allowable throughput degradation. Then, the base station 106 (or other device) finds the regions of <B,D> where degradation is more than the threshold T_{Max}^{_{—}}_{deg} (low throughput regions) if any (step 352).

When several users are being scheduled to transmit data in time-sharing fashion compute burst duration for each user, the base station verifies that <B,D> for each user is not falling into the low throughput regions (below the threshold T_{Max}^{_{—}}_{deg}) (step 354). If one or more users do fall into low throughput regions (as determined at step 356), the base station 106 (or other device) increases burst duration for one or more users so these regions are avoided (step 358).

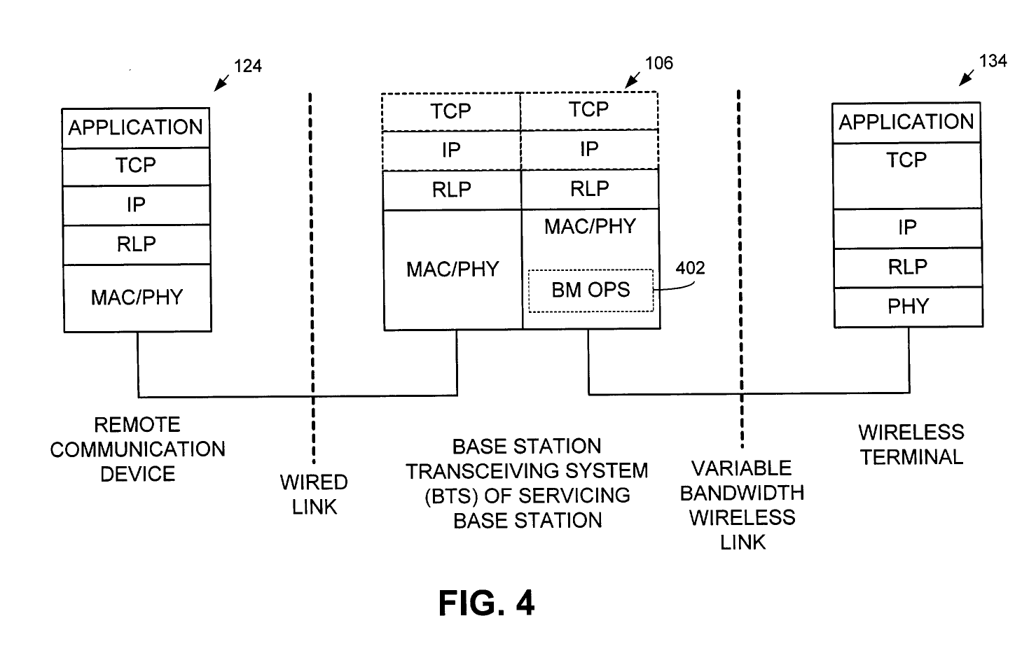

FIG. 4 is a block diagram illustrating a plurality of protocol layers that are supported according to the present invention. As shown, the communication link between the wireless terminal, e.g., 134, and the base station, e.g., 106, includes a variable bandwidth wireless link. The communication link between the base station 106 and the remote communication device, e.g., server 124, includes a conventional wired link.

The wireless subscriber unit 134 and the server 124 have operating thereupon complete protocol stacks that interact with one another via the base station 106, network links, and other intermediate devices. These full protocol stacks include TCP layers in addition to application layers and supporting lower layers. The base station 106 may not require IP and TCP layers for servicing the data communication. Thus, these layers are shown as optional.

According to the present invention, the MAC and/or PHY layer of the base station 106 that services the variable bandwidth wireless link with the wireless terminal 134 has been modified to include Burst Management Operations 402. In such case, the MAC and/or PHY layer now performs operations according to the present invention in managing the burst duration, the burst delay, and the bandwidth ratio of a SCH that services the wireless terminal. By performing these management operations, the base station attempts to support a minimum TCP throughput between the TCP layers of the wireless terminal and the server 124.

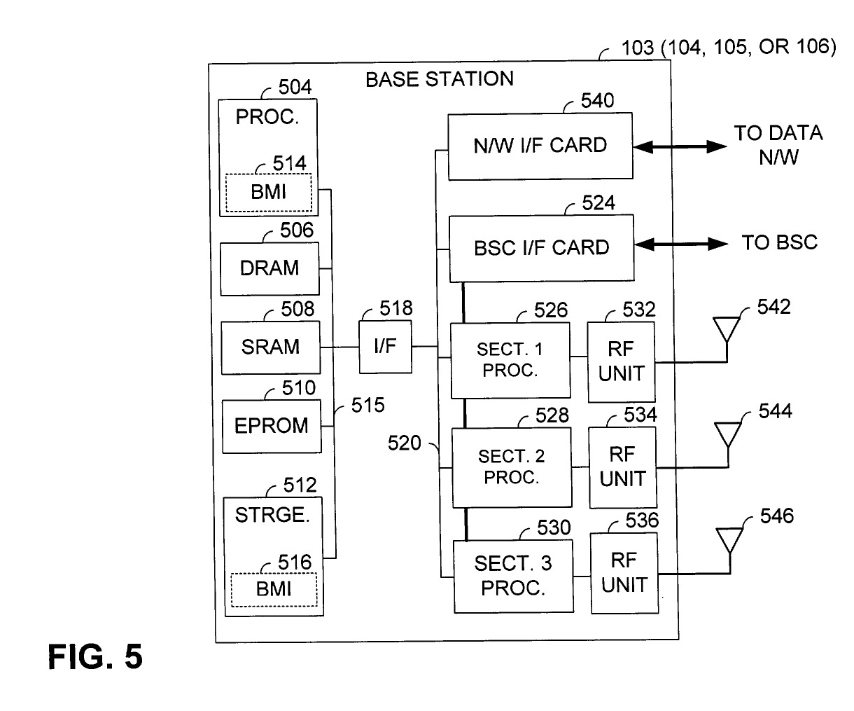

FIG. 5 is a block diagram illustrating the structure of a base station 103 (104, 105, or 106) constructed according to the present invention. The base station 103 includes a processor 504, dynamic RAM 506, static RAM 508, EPROM 510, and at least one data storage device 512, such as a hard drive, optical drive, tape drive, etc. These components (which may be contained on a peripheral processing card or module) intercouple via a local bus 515 and couple to a peripheral bus 520 (which may be a back plane) via an interface 518. Various peripheral cards couple to the peripheral bus 520. These peripheral cards include a BSC interface card 524 that couples the base station 103 to its servicing BSC and a network interface card that couples the base station 103 to a data network.

Digital processing cards 526, 528 and 530 couple to Radio Frequency (RF) units 532, 534, and 536, respectively. Each of these digital processing cards 526, 528, and 530 performs digital processing for a respective sector, e.g., sector 1, sector 2, or sector 3, serviced by the base station 103. The RF units 532, 534, and 536 couple to antennas 542, 544, and 546, respectively, and support wireless communication between the base station 103 and wireless terminals. Further, the RF units 532, 534, and 536 operate according to the present invention.

Burst Management Instructions (BMI) 514 and BMI 514 enable the BSC 103 to perform the operations of the present invention. The BMI 516 are loaded into the storage unit 512 and some or all of the BMI 514 are loaded into the processor 504 for execution. During this process, some of the BMI 516 may be loaded into the DRAM 506.

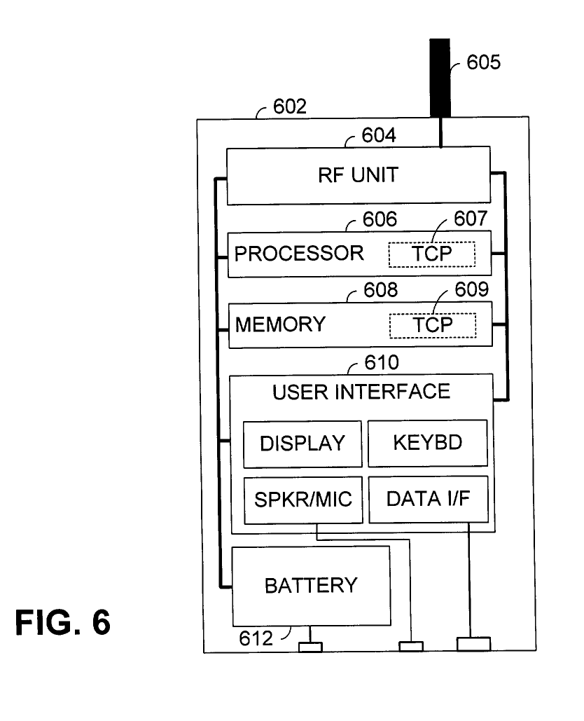

FIG. 6 is a block diagram illustrating the structure of a wireless subscriber unit 602 constructed according to the present invention. The wireless subscriber unit 602 operates within the cellular wireless communication system, such as that described with reference to FIG. 1 (wirelessly enabled laptop computer 134) and according to the operations described with reference to FIGS. 1-4. The wireless subscriber unit 602 includes an RF unit 604, a processor 606, and a memory 608. The RF unit 604 couples to an antenna 605 that may be located internal or external to the case of the wireless subscriber unit 602. The processor 606 may be an Application Specific Integrated Circuit (ASIC) or another type of processor that is capable of operating the wireless subscriber unit 602 according to the present invention. The memory 608 includes both static and dynamic components, e.g., DRAM, SRAM, ROM, EEPROM, etc. In some embodiments, the memory 608 may be partially or fully contained upon an ASIC that also includes the processor 606. A user interface 610 includes a display, a keyboard, a speaker, a microphone, and a data interface, and may include other user interface components. The RF unit 604, the processor 606, the memory 608, and the user interface 610 couple via one or more communication buses/links. A battery 612 also couples to and powers the RF unit 604, the processor 606, the memory 608, and the user interface 610.

The wireless subscriber unit 602 operates according to the present invention as previously described. In its operation TCP layer instructions (TCP) 609 are stored in memory and executed by the processor 607 as TCP 607. The structure of the wireless subscriber unit 602 illustrated is only an example of one wireless subscriber unit structure. Many other varied wireless subscriber unit structures could be operated according to the teachings of the present invention.

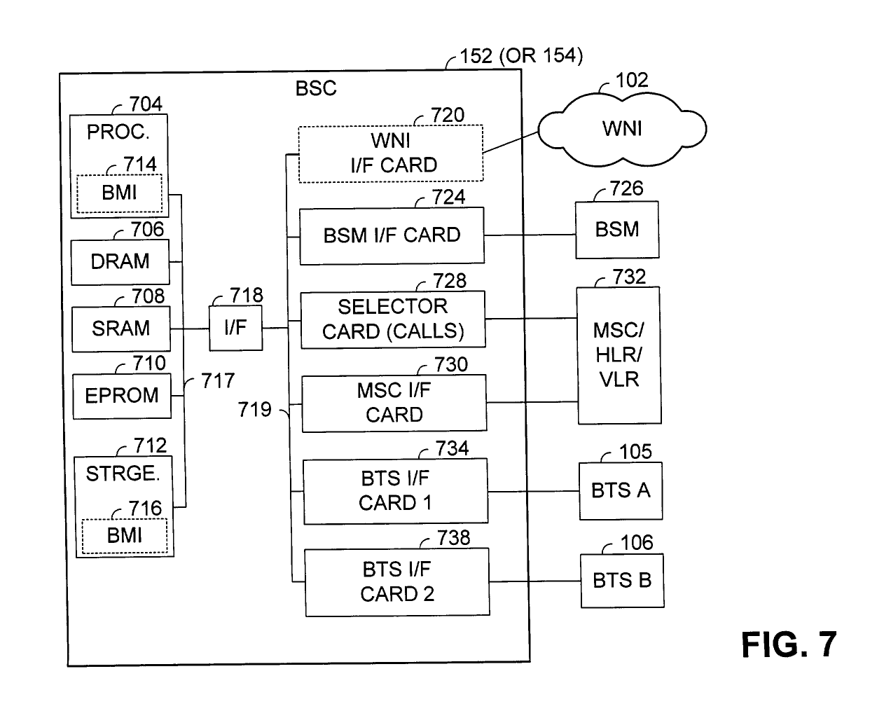

FIG. 7 is a block diagram illustrating a Base Station Controller (BSC) 152 (or 154) constructed according to the present invention. The structure and operation of BSCs is generally known. The BSC 152 services circuit switched and/or packet switched operations. In some cases, the BSC 152 is called upon to convert data between circuit switched and data switched formats, depending upon the types of equipment coupled to the BSC 152. The components illustrated in FIG. 7, their function, and the interconnectivity may vary without departing from the teachings of the present invention.

The BSC 152 includes a processor 704, dynamic RAM 706, static RAM 708, EPROM 710, and at least one data storage device 712, such as a hard drive, optical drive, tape drive, etc. These components intercouple via a local bus 717 and couple to a peripheral bus 719 via an interface 718. Various peripheral cards couple to the peripheral bus 719. These peripheral cards include a wireless network infrastructure interface card 720, a base station manager interface card 724, at least one selector card 728, an MSC interface card 730, and a plurality of BTS interface cards 734 and 738.

The wireless network infrastructure interface card 720 couples the BSC 152 to wireless network infrastructure 102. The base station manager interface card 724 couples the BSC 152 to a Base Station Manager 726. The selector card 728 and MSC interface card 730 couple the BSC 152 to an MSC/HLRIVLR 732. The BTS interface cards 734 and 738 couple the BSC 152 to base stations 105 and 106, respectively.

Burst Management Instructions (BMI) 716 and 714, along with the BSC 152 hardware, enable the BSC 152 to manage the B, D, and O burst parameters of base stations that it controls. The BMI 716 are loaded into the storage unit 712 and, upon execution, some or all of the BMI 714 are loaded into the processor 704 for execution. During this process, some of the BMI 716 may be loaded into the DRAM 706.

The invention disclosed herein is susceptible to various modifications and alternative forms. Specific embodiments therefore have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims.

1. A method for servicing data communications in a cellular wireless communication system that supports data communications on fundamental channels (FCHs) and supplemental channels (SCHs), the method comprising:
determining an operational relationship between a burst duration and a burst delay of the SCHs and Transmission Control Protocol (TCP) layer throughput provided by the cellular wireless communication system, wherein the operational relationship relates TCP layer throughput as a function of the burst duration and burst delay of the SCHs;
servicing, by a base station of the cellular wireless communication system, data communications for a plurality of wireless terminals using a plurality of FCHs and at least one SCH; and
managing the burst duration and the burst delay of the at least one SCH in an attempt to provide a minimal TCP layer throughput degradation for at least some of the plurality of wireless terminals.

2. The method of claim 1:
wherein the operational relationship is also a function of bandwidth ratio of the SCHs and FCHs; and
further comprising managing the bandwidth ratio of the at least one SCH and the plurality of FCHs in an attempt to provide a minimal TCP layer throughput degradation for at least some of the plurality of wireless terminals.

3. The method of claim 2, wherein the bandwidth ratio is equal to the sum of a SCH bandwidth and a FCH bandwidth divided by the FCH bandwidth.

4. The method of claim 1, further comprising managing the allocation of the at least one SCH in an attempt to provide a minimal TCP layer throughput degradation for at least some of the plurality of wireless terminals.

5. The method of claim 1, wherein TCP layer throughput degradation is characterized as a percentage of maximum allowable TCP throughput.

6. The method of claim 1, wherein managing the burst duration and the burst delay of the at least one SCH is performed so that at least some of the plurality of wireless terminals receives at least a minimum percentage of maximum allowable TCP throughput.

7. The method of claim 1, wherein managing the burst duration and the burst delay of the at least one SCH is performed so that each of the plurality of wireless terminals receives at least a minimum percentage of maximum allowable TCP throughput.

8. The method of claim 1, wherein managing the burst duration and burst delay of the at least one SCH in an attempt to provide a minimal TCP layer throughput degradation for at least some of the plurality of wireless terminals is performed by a Radio Resource Manager operating at the base station.

9. The method of claim 1, wherein the at least one SCH is shared by the plurality of wireless terminals.

10. The method of claim 1, wherein the at least one SCH includes a plurality of SCHs.

11. A cellular wireless communication system that supports data communications on fundamental channels (FCHs) and supplemental channels (SCHs), the cellular wireless communication system comprising:
a wireless network infrastructure that operably couples to at least one data network;
at least one base station operably coupled to the wireless network infrastructure that services data communications for a plurality of wireless terminals using a plurality of FCHs and at least one SCH; and
wherein the base station manages a burst duration and a burst delay of the at least one SCH in an attempt to provide a minimal Transmission Control Protocol (TCP) layer throughput degradation for at least some of the plurality of wireless terminals, wherein the base station manages the burst duration and burst delay of the at least one SCH based upon an operational relationship between TCP layer throughput and burst duration and burst delay of the at least one SCH.

12. The cellular wireless communication system of claim 11, wherein:
the operational relationship is also a function of a bandwidth ratio of the SCHs and FCHs; and
the base station manages the bandwidth ratio of the at least one SCH and the plurality of FCHs in an attempt to provide a minimal TCP layer throughput degradation for at least some of the plurality of wireless terminals.

13. The cellular wireless communication system of claim 12, wherein the bandwidth ratio is equal to the sum of a SCH bandwidth and a FCH bandwidth divided by the FCH bandwidth.

14. The cellular wireless communication system of claim 11, wherein the base station manages the burst duration and the burst delay of the at least one SCH so that at least some of the plurality of wireless terminals receives at least a minimum percentage of a maximum allowable TCP throughput.

15. The cellular wireless communication system of claim 11, wherein the base station manages the burst duration and the burst delay of the at least one SCH so that each of the plurality of wireless terminals receives at least a minimum percentage of maximum allowable TCP throughput.

16. The cellular wireless communication system of claim 11, wherein the at least one SCH is shared by the plurality of wireless terminals.

17. The cellular wireless communication system of claim 11, wherein the at least one SCH includes a plurality of SCHs.

18. A cellular wireless communication system base station that supports data communications on fundamental channels (FCHs) and supplemental channels (SCHs), the base station comprising comprising:
a network interface that operably couples the base station to at least one data network;
at least one wireless interface operably coupled to the network interface that services data communications for a plurality of wireless terminals using a plurality of FCHs and at least one SCH;
a processor operably coupled to the network interface and to the at least one wireless network interface; and
a memory operably coupled to the processor that stores a plurality of software instructions executable by the processor that, upon execution cause the base station to manage a burst duration and a burst delay of the at least one SCH in an attempt to provide a minimal Transmission Control Protocol (TCP) layer throughput degradation for at least some of the plurality of wireless terminals, wherein the base station manages the burst duration and burst delay of the at least one SCH based upon an operational relationship between TCP layer throughput and burst duration and burst delay of the at least one SCH.

19. The base station of claim 18, wherein:
the operational relationship is also a function of a bandwidth ratio of the SCHs and FCHs; and
execution of the software instructions also cause the base station to manage the bandwidth ratio of the at least one SCH and the plurality of FCHs in an attempt to provide a minimal TCP layer throughput degradation for at least some of the plurality of wireless terminals.

20. The base station of claim 11, wherein the at least one SCH includes a plurality of SCHs.
